(19) United States
(12) Patent Application Publication
(10) Pub. No.: US 2024/0403392 A1
(43) Pub. Date: Dec. 5, 2024

(54) SYSTEM AND METHOD FOR TRACKING OF ASSETS

(71) Applicant: NAGRAVISION SARL, CHESEAUX-SUR-LAUSANNE (CH)

(72) Inventors: Matthieu Michelet, CHESEAUX-SUR-LAUSANNE (CH); Pascal Métral, CHESEAUX-SUR-LAUSANNE (CH); Michael Sharp, CHESEAUX-SUR-LAUSANNE (CH); Clément Marx, CHESEAUX-SUR-LAUSANNE (CH); Adrien Chinelli, CHESEAUX-SUR-LAUSANNE (CH); Jerry Gee, CHESEAUX-SUR-LAUSANNE (CH)

(73) Assignee: NAGRAVISION SARL, CHESEAUX-SUR-LAUSANNE (CH)

(21) Appl. No.: 18/721,899

(22) PCT Filed: Dec. 29, 2022
(86) PCT No.: PCT/EP2022/088039

§ 371 Date: Jun. 20, 2024

(30) Foreign Application Priority Data
Dec. 29, 2021 (EP) 21218229.9

(51) Int. Cl. G06F 21/10

(52) U.S. Cl. CPC G06F 21/1014; G06Q 2220/10

(57) ABSTRACT

The present disclosure relates to asset tracking. In particular, the present disclosure relates to facilitating asset supervision and monitoring. Further in particular, the present disclosure relates to a system and method incentivising user behaviour to increase a reliability of the asset tracking. Accordingly, there is provided a method (300) for tracking of at least one asset, comprising the steps receiving (302) ID information (108) of a particular asset, receiving (304) user information of a particular user, receiving (306) location information, wherein the location information is location information of the asset and/or the user, storing (308), in a database, tracking information based on at least one of the received information, associated with the asset, determining (310), based on at least one of the received information, whether to provide ancillary information associated with the asset to the user, determining (312), based on the user information, information to be transmitted to the user, wherein the information to be transmitted is at least a subset of the ancillary information associated with the asset, and providing (314) said information to be transmitted to the user.

### TECHNICAL FIELD

The present disclosure relates to asset tracking. In particular, the present disclosure relates to facilitating asset supervision and monitoring. Further in particular, the present disclosure relates to a system and method incentivising user behaviour to increase a reliability of the asset tracking.

### BACKGROUND

The present disclosure relates to the tracking of assets. In our globalised world, assets, i.e., products of a specific manufacturer or vendor, are often shipped on a global, worldwide scale. In consequence, a particular asset, on its way from the manufacturing site to the end-user passes through a multitude of locations, possibly accompanied by several changes in ownership. A manufacturer, located in a particular country, may sell assets to a local distributor that in turn sells the product to various national or regional distributors worldwide. They in turn are responsible for reselling and distributing the product to retailers in their region, which in turn sell the asset to the end user or consumer.

It may thus be difficult for the original manufacturer to maintain an overview of the complete retail channel if the asset passes through a plurality of subsequent and separate entities, possibly independent and not directly associated with the manufacturer. Maintaining such an overview however is beneficial for the original equipment manufacturer (OEM) as it allows on the one hand determining where a particular asset is finally sold to the end user on the worldwide market, and on the other hand, by generating a reliable location or travel history of the asset, to assure that the asset is indeed an asset manufactured by the OEM. In other words, maintaining such an overview provides means for counteracting against grey market sale of an asset and/or means for determining whether a particular asset is a counterfeit product not manufactured by the OEM.

Thus, there may be a need for establishing a reliable and verifiable travel history of an asset by tracking the asset through the various stages of transportation from the manufacturer to the end user.

Further, there may be a need to reliably associate ID information with a particular asset.

### SUMMARY

At least one such need may be met by the subject-matter of the independent claims. Preferred embodiments are provided in the dependent claims and are explained in detail in the following description.

The present invention relates to a method and a system for tracking of an asset as well as a computer readable storage medium and a computer program product.

According to a first aspect of the disclosure, there is provided a method for tracking of at least one asset, comprising the steps receiving ID information of a particular asset, receiving user information of a particular user, receiving location information, wherein the location information is location information of the asset and/or the user, storing, in a database, tracking information based on at least one of the received information, associated with the asset, determining, based on at least one of the received information, whether to provide ancillary information associated with the asset to the user, determining, based on the user information, information to be transmitted to the user, wherein the information to be transmitted is at least a subset of the ancillary information associated with the asset, and providing said information to be transmitted to the user.

According to a second aspect of the disclosure, there is provided a system for tracking of at least one asset, the system comprising a communication element, adapted for communication with at least one user of the system, a database for storing information about a particular asset and/or a particular user, and a processing element, adapted to receive ID information of a particular asset, receive user information of a particular user, receive location information, wherein the location information is location information of the asset and/or the user, store, in the database, tracking information based on at least one of the received information, associated with the asset, determine, based on at least one of the received information, whether to provide ancillary information associated with the asset to the user, determine, based on the user information, information to be transmitted to the user, wherein the information to be transmitted is at least a subset of the ancillary information associated with the asset, and provide said information to be transmitted to the user.

According to a third aspect of the disclosure, there is provided a method for asset tracking and information provisioning, comprising the steps providing a physical asset comprising ID information, providing a virtual NFT asset comprising NFT-ID information, wherein the ID information of the physical asset and the NFT-ID information of the virtual asset are linked, providing user information of a user linked to the physical asset and/or the virtual NFT asset, storing, in a blockchain, tracking information associated with the physical asset and the NFT asset and based on at least one of the provided information, determining, based on at least one of the physical asset ID information, the virtual NFT asset NFT-ID information and the user information, information available to and/or to be transmitted to the user, wherein the determining information comprises determining the information as a subset of ancillary information associated with the physical asset based on at least one of the ID information, the NFT-ID information, the user information, user ID information, the validity of the ID information, the validity of the NFT-ID information, the validity of the user information, the validity of the user ID information, user type information, user security level information, and providing said subset of ancillary information to the user upon request.

According to a fourth aspect of the disclosure, there is provided a system for asset tracking and information provisioning, the system comprising a communication element, adapted for communication with at least one user of the system, a database for storing information about a particular asset and/or a particular user, and a processing element, adapted to receive ID information associated with a physical asset, receive NFT-ID information associated with a virtual NFT asset, wherein the ID information of the physical asset and the NFT-ID information of the virtual asset are linked, receive user information of a user linked to the physical asset and/or the virtual NFT asset, store, in the blockchain, tracking information associated with the physical asset and the NFT asset and based on at least one of the received information, determine, based on at least one of the physical asset ID information, the virtual NFT asset NFT-ID information and the user information, information available to and/or to be transmitted to the user, wherein the determining information comprises determining the information as a subset of ancillary information associated with the physical asset based on at least one of the ID information, the NFT-ID information, the user information, user ID information, the validity of the ID information, the validity of the NFT-ID information, the validity of the user information, the validity of the user ID information, user type information, user security level information, and provide said subset of ancillary information to the user upon request.

According to a fifth aspect of the disclosure, there is provided a method for tracking of at least one asset, comprising the steps receiving ID information of a particular asset receiving user information of a particular user, wherein the user information comprises at least one of user ID information, user type information and user security level information, receiving location information, wherein the location information is location information of the asset and/or the user, storing, in a database, tracking information based on at least one of the received information, associated with the asset, determining, based on at least one of the received information, whether to provide ancillary information associated with the asset to the user, determining, based on the user information, information to be transmitted to the user, wherein determining information to be transmitted to the user comprises determining which ancillary information associated with the asset to provide to the user comprising determining at least one of the validity of the ID information, the validity of the user information, the user ID information, the user type information, the user security level information and the location information, wherein the information to be transmitted is a subset of the ancillary information associated with the asset, and providing said information to be transmitted to the user.

According to a sixth aspect of the disclosure, there is provided a system for tracking of at least one asset, the system comprising a communication element, adapted for communication with at least one user of the system, a database for storing information about a particular asset and/or a particular user, and a processing element, adapted to receive ID information of a particular asset, receive user information of a particular user, wherein the user information comprises at least one of user ID information, user type information and user security level information, receive location information, wherein the location information is location information of the asset and/or the user, store, in the database, tracking information based on at least one of the received information, associated with the asset, determine, based on at least one of the received information, whether to provide ancillary information associated with the asset to the user, determine, based on the user information, information to be transmitted to the user, wherein determining information to be transmitted to the user comprises determining which ancillary information associated with the asset to provide to the user comprising determining at least one of the validity of the ID information, the validity of the user information, the user ID information, the user type information, the user security level information and the location information, wherein the information to be transmitted is a subset of the ancillary information associated with the asset, and provide said information to be transmitted to the user.

According to a seventh aspect of the disclosure, there is provided a computer-readable storage medium comprising instructions which, when executed by a processing element, cause the processing element to carry out the steps of the method according to the present disclosure.

According to an eighth aspect of the disclosure, there is provided a computer program product comprising instructions which, when executed by a processing element, cause the processing element to carry out the steps of the method according to the present disclosure.

According to a ninth aspect of the disclosure, there is provided a method for asset tracking and information provisioning, comprising the steps providing a physical asset comprising ID information, providing a virtual NFT asset comprising NFT-ID information, wherein the ID information of the physical asset and the NFT-ID information of the virtual asset are linked, providing user information of a user linked to the physical asset and/or the virtual NFT asset, storing, in a blockchain, information associated with the physical asset, the virtual NFT asset and the user information.

The global economy imposes a large variety of risks for manufacturers of assets both with regard to counterfeit products, thus the imitation of a products by a third-party, and the grey market sale of essentially genuine products through an unofficial trade channel. Both can be subsumed under the term illicit trade.

Counterfeit products are essentially imitations of otherwise authentic products by a third-party with the intent to imitate, steal, destroy or replace the authentic product, for use in illegal transactions or otherwise to deceive customers into believing that the fake product is indeed the original, thereby implying that the counterfeit product is of equal or greater value than the genuine product. Any industry with high value products and/or strongly controlled products is particular susceptible to illicit trade.

Counterfeit products may be any product of sufficient value to the end user, be it depended on price or scarcity/availability, so that counterfeiting efforts are rendered profitable. E.g., fake pharmaceuticals, fake luxury watches, designer clothing and bags, cosmetics, wine, car parts and tobacco products to only name a few are usual targets for counterfeit goods. Grey market sale of goods may in turn be authentic products which are however sold through unauthorised channels that escape appropriate regulation either by the manufacturer themself or the legislator. E.g., luxury goods are sold below brand imposed pricing, prescription drugs are sold without requiring a prescription or more generally the sale of products may occur in a geographical region different from the intended geographical region by the manufacturer or distributor.

Both the sale of counterfeit products and grey market sales may thus lead to significant revenue loss and brand devaluation for the OEM. Further, the sale of non-authentic products may potentially be a risk to consumer safety, which again may reflect negatively on the brand of the OEM in case of an incident.

In light of this, the present disclosure provides for a tracking of assets including monitoring and intelligence that subsequently allows the determination of the origin of a particular asset as well as the determination whether an asset indeed is a genuine asset, produced by the OEM. This determination may be beneficial for various stakeholders, in particular the OEM, the distributors but also the end user or customer.

In order to provide a reliable and in particular untamperable tracking, the present disclosure employs, in particular unique, ID information associated with a particular asset. The ID information is preferably physically attached to the asset or otherwise arranged in its vicinity so to allow an unambiguous correlation between the ID information and the asset. The ID information may in particular comprise an electronic signature or may be otherwise cryptographically secured ID information. In order to reliably determine a location where an asset is currently located, the present disclosure provides the acquisition of the ID information by a user, while the location of the user is known. The ID information, the location information and user information, which may be identification information of a particular user acquiring the ID information may be associated.

Already this set of information allows the checking of the reliability of the information. E.g., in case it is known that a particular user regularly operates at a defined location, a first check may be whether the acquired location corresponds to the usual user location. At the same time, a history of locations and expected future locations or a defined route that a particular asset is expected to travel before initiating shipment allows a plausibility verification whether a particular asset identified by the ID information currently is indeed at a location corresponding to an expected location. In case it is determined that the asset is at a location that is unexpected, an alarm or information may be triggered and sent to the OEM or distributor.

Likewise, it may be determined whether a particular user is expected to acquire the ID information of a particular asset. For example, a user may regularly receive a specific type of asset intended for the region of the user, and this may be verified by the information acquired. When the user suddenly is acquiring ID information of possibly the same type of asset which is however not intended for the specific region of the user, such may trigger an alarm or information which is in turn sent to the OEM or the distributor. E.g., pharmaceuticals, perfumes or the like, which are being acquired while being outside of their intended region may trigger an alarm or an information is sent to the OEM or distributor informing them that potentially a shipment is being redirected, which may indicate the grey market sale of assets.

Further, in case the user is scanning ID information that does not correspond to valid ID information, an alarm or information may be triggered and sent to the OEM or distributor. Also, the user may be informed that the asset that was just scanned may be an asset that is not a genuine product originating from the OEM or distributor and may thus be a counterfeit asset. In this scenario, as soon as a counterfeit asset is introduced into the retail channel, the OEM or distributor learns of this and may thus react by removing such counterfeit assets from the market. Also, the location of first acquisition of counterfeit products may feed into an intelligence analysis, providing information on the geographic region where a fraudulent action may be assumed to have occurred.

Similarly, an end user or consumer may scan the ID information and subsequently may receive information whether the product they are about to purchase or have purchased is a genuine product or possibly counterfeit. In case of a grey market resale of assets, the end user may not necessarily be informed accordingly, as long as the asset is confirmed to still be genuine, and the sale is in compliance with all local market regulations.

Once the user acquires ID information of a particular asset, thereby associating a location information with the particular asset, the acquired information may be stored in a database. Such a database may preferably be associated with or accessible by the OEM or distributor. Acquiring a plurality of such datasets allows the continued tracking of the asset through the retail channel.

In order to incentivise the build-up of such a tracking history of a particular asset by repeated scanning of the ID information of that asset by users throughout the retail chain, the present disclosure provides that information related to the particular asset and relevant to the user and/or the location of the asset is provided to the user in response to scanning the particular asset.

For example, a user who is identified as a local retailer may receive authenticity information on the particular asset so to assure that the product is a genuine product. Alternatively, or additionally, the user may receive handling instructions and expiry information on a particular asset. E.g., the user may receive information that the asset needs to be stored at a defined temperature and needs to be sold off until a defined date, as it would otherwise expire. Still further, a user who is identified as an end user or consumer may again receive authenticity information on the particular asset and may receive information regarding the usage of the asset, exemplarily a manual of operation, or prescription information in case the asset is a pharmaceutical.

Essentially, providing this ancillary information, or at least a subset of the stored ancillary information, dependent on the user type, incentivises the acquisition of the asset by the user, and thereby facilitates the build-up of the tracking information.

In a preferred embodiment, location information of both the asset and the user is acquired. The location information may be acquired in the same modality, e.g., both acquired are by using a global positioning system, or using different modalities. This may in particular increase the reliability of the location information. The location information of the asset and the user may be correlated and/or fused so to ascertain or verify the reliability of the location information. This correlation may be done before providing the location information to a further party, i.e., so that already verified location information is provided, which is more reliable, or both sets of location information can be provided, and only later verified and/or stored. An indication may be provided indicating whether the location information is a singly acquired location information, or plurally acquired location information, e.g., of both the asset and the user.

The ID information may be arranged so that it cannot be copied or otherwise duplicated, e.g., photographed, and used or even reused at a later time, e.g., at a different location. E.g., the ID information may comprise a watermark indicator, so to prohibit or at least detect, possibly unauthorized, duplication. The ID information may, e.g., have a marker or information, which cannot be copied and/or reproduced when being photographed.

The relevance of assuring correctness of location information, e.g., the decision whether to obtain and correlate a plurality of independent sets of location information, for example of the asset and the user, may depend on a particular use case or business model. For a certain type of asset, it may be sufficient to only acquire a single location information, while for a further type of asset, the provision of a verified/correlated set of location information, or a plurality of location information may be required, e.g., before providing the information to be transmitted to the user.

One particularly beneficial way of tracking a physical asset through a value chain, e.g., from manufacture to distribution to retail and to the end user is to track the different steps of the physical asset through the value chain. The respective steps of the physical asset may be recorded and stored appropriately, in particular preferably in an unalterable way, so that any owner or proprietor of the physical asset in turn may trace the way of the asset through the value chain. Since the information relating to the physical asset are by nature separate from the physical asset (unless the information relating to the physical asset are stored on the physical asset) it is beneficial to generate a virtual copy or virtual representation of the physical asset, i.e., a virtual asset, and link the information relating to the physical asset to the vertical asset. In this way, information relating to the physical asset stored in digital form, can be linked to the virtual asset, in particular in an unalterable way. Thereby, any user accessing the information relating to the physical asset may access said information through the virtual asset.

In order to provide a virtual asset in an unalterable manner, said asset may be created as a so-called non-fungible token. A non-fungible token (NFT) is a unique digital identifier that cannot be copied, replaced, or split, and that may be recorded on a blockchain. The NFT may be used to certify authenticity and ownership. Ownership of an NFT is recorded on the blockchain and may be transferred by the owner, allowing NFTs to be sold and traded. NFTs typically contain references to digital information, like, e.g., digital files such as photos, videos, and audio files. NFTs are uniquely identifiable assets.

Essentially, an NFT is a unit of data stored in a type of digital ledger called a blockchain that can be sold and traded. In the context of the present disclosure, the NFT may be associated with specific digital information and/or a physical asset. NFTs function like cryptographic tokens, but unlike cryptocurrencies such as Ethereum, NFTs are not mutually exchangeable and therefore not fungible. In other words, an NFT is an object programmable, and after generation, properties or information may be associated with the NFT. Some properties may be modified by different users. E.g., some categories of users, e.g., dependent on user information, user ID information, user type information, user security level information and user location information, may be able to add or modify select properties or information that other users may not. E.g., a manufacturer may associate a colour or a serial number to a virtual asset/NFT, but the colour or the serial number may not be modified by a retailer or an end user. Alternatively, in case the physical asset is exemplarily an electronic, battery powered device, any (current) user may modify a “last charged” date associated with the virtual asset/NFT.

The NFT or a unique ID of the virtual asset, e.g., an NFT-UID, may be linked to the physical asset and the ID or UID of the physical asset. The UID may e.g., be stored in an electronic solution like a secure element. In this context the secure element may ensure that the ID associated to an asset may not be cloned. In order to provide this functionality, the secure element may authenticate the asset by a signature. If a secure element is associated to the asset. the secure element may contain a public private key pair. The private key is kept in the secure element and will be used to identify and verify the asset, and the public key is associated to the ID of the asset stored in the NFT. For instance, the asset NFT ID may be related to the hash of the public key stored in the secure element associated with the asset.

By linking the ID of the physical asset with the ID of the NFT, the physical asset may be associated to the NFT in a blockchain. In this way, the owner or proprietor of the physical asset may own the linked NFT, which thereby symbolizes ownership of the physical asset. During the sale/purchase of the physical asset, the buyer may verify the seller's ownership of the physical asset by verifying the ownership of the NFT in the blockchain. The NFT is owned by an entity in the blockchain when associated to their wallet. Such an ownership may be proven by using a public-private key pair on the NFT entry and the blockchain. The seller may thereby verify ownership of the virtual asset, the NFT on the blockchain, so that the seller may obtain the information that the virtual asset and thus the physical asset is owned by the seller.

A blockchain may thus store the lifecycle of the physical asset in an unalterable way, so that any user, who is e.g., about to purchase a physical asset may verify the chain of ownership of the physical asset by retracing the chain of ownership of the NFT on the blockchain. Such a chain of ownership may start with the manufacturer of the physical asset generating the associated virtual asset/NFT. The manufacturer may subsequently sell the physical asset to a distributor and record said sale on the blockchain by transmitting the ownership of the virtual asset/NFT from itself (the manufacturer) to the distributor. The distributor in turn may do the same when selling the physical asset to a retailer, where the retailer may be recorded as the owner of the virtual asset/NFT. The retailer in turn may verify that the distributor is indeed the owner of the physical asset by verifying the ownership of the virtual asset/NFT. Still further, and end-user may verify that a retailer selling a physical asset is indeed the owner of the physical asset by verifying ownership of the virtual asset/NFT. The end user may trace the chain of ownership back to the manufacturer and may thus deduce that the physical asset indeed is genuine, i.e., has been manufactured by the correct manufacturer. Every time the physical asset is sold, i.e., ownership of the physical asset is transferred, said transfer of ownership is recorded on the blockchain by transferring the ownership of the virtual asset/NFT on the blockchain.

The information on the blockchain about the virtual asset/NFT may be secured, e.g., cryptographically secured, e.g., encrypted, so that only a user who is part of the specific value chain or chain of sale may access information about said virtual asset/NFT and thus obtains information about the linked physical asset. E.g., in case the physical asset is a watch, only a user being a member of the value chain may access information associated with the virtual asset/NFT. In this example, a user may access the serial number of the watch, or any other information stored in relation to the physical asset only if they can prove that they are or have been an owner of the virtual asset/NFT.

Regularly, information stored in the blockchain is accessible to everyone. If information is to be kept confidential it may preferably be stored outside the blockchain in a secured storage. In such a case, the following process steps may be performed: The information is stored in the secure storage, the information is signed, and this signature may be stored in the NFT properties. In case someone wants to access the information, the smart contract may check that the user has the right to access said information, and the secure storage may forward the information (e.g., encrypted with the public key of the user), and the user may check that the info in authentic by checking the data signature stored in the NFP.

A specific user may only access or obtain a subset of the information available in relation to a particular physical asset. E.g., an end user may access information about the manufacturer to verify whether the physical as it is genuine and additional information like an operations manual. A distributor in turn may receive information about the physical asset like production information and release information, whereas a retailer may receive information like storage instructions. The manufacturer in turn may receive information which retailer ultimately sold the physical asset to an end user without receiving information on the end user themselves due to data privacy laws.

A user in the context of this disclosure may be any institution, entity, company or person. Different entities or stakeholders may be considered who may interact with the NFT. All those entities may be associated to the physical asset in the real world, in particular at a certain point in time. A user may thus be production actor, retailers or a simple owner or proprietor.

Each user interacting with the blockchain may need a key-pair (public and private key). The key pair may also be referred to as wallet. The private key may be used to sign the transaction or NFT properties transformations. The public key may be associated to a certain account of a user or an entity, which may even be anonymous.

When a physical asset is transferred from one user to another in the real world, the virtual asset/NFT may be transferred from one user to another in the blockchain via a transaction managed by a smart contract. The transaction may be done with a crypto currency, in which case the value transfer may be managed in the blockchain. Alternatively, the value transfer may be performed in the real world, e.g., with fiat currency, in which case the virtual asset/NFT transfer is not associated with a crypto-currency transfer. Each transaction may be recorded in the blockchain. By this way full traceability of the physical asset is provided. The creation of the NFT may be done by the production entity/manufacturer, where the NFT may be associated to a unique ID of the physical asset.

Information stored in the blockchain are usually “public”. If an information must be kept as confidential, it may be managed by an external entity in addition to the virtual asset/NFT, but the confidential information is linked, e.g., cryptographically linked to the virtual asset/NFT. Such an entities, also referred to as an oracle, may interact with the blockchain and divulge information associated with the physical asset which can be considered authentic, but may keep the source or other data that should not be accessible to a particular user confidential.

The blockchain may be implemented using a public blockchain (e.g., Ethereum, Solana, Algorand) or a private blockchain, which may be managed by one or more stake holders, which are typically users/entities that have an interest to demonstrate the traceability.

According to an embodiment of the present disclosure, the method may further comprise optionally providing location information, wherein the location information is location information of the physical asset (106) and/or the user, wherein the determining information comprises determining the information as a subset of ancillary information associated with the physical asset based on at least one of the ID information, the NFT-ID information, the user information, user ID information, the validity of the ID information, the validity of the NFT-ID information, the validity of the user information, the validity of the user ID information, user type information, user security level information and location information of the physical asset and/or the user.

Using location information of the physical asset and/or the user may increase reliability and/or authenticity of a transaction. E.g., a transfer of ownership of a virtual NFT asset recorded on the blockchain that has taken place at a time where the physical asset as well as the user selling and/or the user purchasing the asset are located at essentially the same location may be considered reliable and/or authentic. Authenticity or reliability may be increased further in case the location is determined as the place of business of the user selling the physical asset, e.g., a retail store for watches in the inner city of Lucerne. Information provided to a user in turn may depend on the location. E.g., storage instructions of a physical asset located in the Sahara Desert may be different from storage instruction of her physical asset located on a glacier.

According to a further embodiment of the present disclosure, the user may be one of a person or an entity.

According to a further embodiment of the present disclosure, the user may be a manufacturer of the physical asset, and the method may further comprise generating the virtual NFT asset and storing information on the virtual NFT asset in the blockchain, wherein the virtual NFT asset is a non-fungible token.

A preferable way of generating the virtual NFT asset is that the virtual NFT asset is generated by the same user or associated users that manufactured the physical asset. Here, the initial proprietor of the physical asset is the same as the initial proprietor of the virtual NFT asset and thus the start of the chain of trust is verifiable. Preferably, the identity of the user generating the virtual NFT asset, and the physical asset and their association is publicly verifiable. Such an identity or association may be a verifiable by the blockchain as well.

According to a further embodiment of the present disclosure, linking the ID information of the physical asset and the NFT-ID information of the virtual NFT asset may comprise at least one of a secured link, a cryptographically secured link, a signed link, an unalterable link.

In other words, the ID information of the physical asset and the NFT-ID information of the virtual NFT asset shall be reliably verifiable by a third party. E.g., a user about to purchase a physical asset should be able to verify that the virtual NFT asset assumed to correspond to the physical asset is indeed the correct virtual NFT asset and thus the information stored in relation to the virtual NFT asset is correct and refers to the respective physical asset. It is preferable that such a link between the physical asset and the virtual NFT asset, once established, may not be broken or otherwise invalidated.

According to a further embodiment of the present disclosure, linking of the user to the virtual NFT asset may comprise linking the ownership and/or the proprietorship of the physical asset to said user.

According to a further embodiment of the present disclosure, the method may comprise transferring the virtual NFT asset from the user to a second user when the ownership and/or the proprietorship of the physical asset is transferred from the user to said second user.

In this regard, the ownership of the virtual NFT asset may be an indication that a particular user indeed is the owner or proprietor of the physical asset, depending on a certain legal framework in the real world. Alternatively, a transfer of ownership or proprietorship of the physical asset may result in an automatic transfer of the ownership of the virtual NFT asset from the user selling the physical asset to the user acquiring the physical asset. By an automatic transfer, i.e., an automatic recording of the transfer of the NFT asset from the current owner to a new owner of the physical asset, the chain of ownership may be reliably stored in the blockchain, in particular without external input.

To enforce the role or the existence of the different users, the entities or user may be enrolled in the smart contact by one or several trusted parties, associating those entities or users to a role and right, potentially verifying that those entities exist in the real word. Thus, each user or entity has a certificate, e.g., valid for a limited period of time, and linking the entity/user ID/their wallet public key with a roles right activities category.

According to a further embodiment of the present disclosure, the ID information may be acquired by the user from the asset, in particular acquired in the near field at the location of the asset.

In order to assure that the location of the acquired asset corresponds to the user location, measures may be taken to assure that the user can only acquire ID information when actually being at the asset location or in its vicinity. In other words, a remote acquisition of ID information may be prohibited, so to assure that location of the user essentially coincides with the location of the asset. At the same time this assures that only the user close to the asset is able to acquire the ancillary information relevant to the particular user and or the particular location of the asset. In other words, this assures that the location of the asset is verifiably correct and thus is reliable.

E.g., in case the user is associated with a particular trust level, the location information of the asset may share the trust level, if said particular user is acquiring the asset specific ID information.

According to a further embodiment of the present disclosure, the asset may comprise a localised ID information element and the localised ID information element may be associated with the ID information so that the user may acquire the idea information in the near field at the location of the asset, in particular from the localised ID information element.

In other words, by using a localised ID information element, it is assured that the user can acquire the ID information only when being in the near field of the asset, i.e., at all rounds, near or in the vicinity of the asset. In particular, the near field may be such that the ID information may be optically acquired by the user using a dedicated acquisition device. E.g., in case the localised ID information element displays the ID information, the user may acquire the ID information while scanning displayed information on the localised ID information element. Additionally, or alternatively, the localised ID information elements may comprise an electronic component like and electromagnetic transmission that is only a receivable by a suitable acquisition device in the near field. E.g., a near-field Bluetooth connection, NFC communication or the like may allow the acquisition of the ID information in the near field.

A combination of an optical localised ID information element like a barcode, which could potentially be copied by photographing, with electronic means for assuring that the user needs to be in the vicinity of the actual asset like the before mentioned near field communication connection, may be conceivable.

According to a further embodiment of the present disclosure, the ID information may include signature information, in particular the ID information may be cryptographically secured ID information, and the method may further comprise verifying the signature of the ID information and/or the cryptographically secured ID information for determining the validity of the ID information.

By providing a signed or cryptographically secured ID information, a user acquiring the ID information may easily verify the authenticity of the ID information and/or whether the ID information has been tampered with. Further, by such means, a simple duplication of the ID information may be prohibited, so to assure that each ID information, in particular a localised ID information element, is genuine and unique. Likewise, by assuring that a localised ID information element is genuine and unique, allows to assure that the location information acquired by acquisition of the ID information is also genuinely the location information of the asset.

According to a further embodiment of the present disclosure, the user information may comprise at least one of user ID information, user type information and user security level information, and wherein determining whether to provide ancillary information and/or which ancillary information associated with the asset to provide to the user may comprise determining at least one of the validity of the ID information, the validity of the user information, the user ID information, the user type information, the user security level information and the location information.

The ancillary information may comprise a plurality of different sets of information where each set may only be relevant to a specific user or a specific user type. E.g., in case a user is identified as a retailer by either their specific retailer ID or by being identified by the general retailer user type, a subset of information of the ancillary information on the relevant to that specific retailer may be provided to the user. For example, the retailer may receive stocking information or availability information of the type of asset and may thereby adapt the sale activities accordingly. Additionally, or alternatively, the information may comprise handling information, safety information or generally information relevant to a retailer. In case the user is identified as a customer or end user, a different subset or a partially overlapping subset of ancillary information may be provided to the user. E.g., in case of an end user, a product manual, storage information and exploration information may be provided.

Further, only a user with a specific security level may be authorised to receive a specific set of information. Likewise, a user may additionally or alternatively be identified or associated with a specific security level for accessing the ancillary information. E.g., a user with a specific security level may in turn receive access to the previous tracking information. For example, in case the user is a local distributor, the user may receive the previous tracking information from the OEM through the distribution network. In case the user is an end user or consumer, thereby having a different, possibly lower security level, such tracking information may not be available.

User ID information, user type information and/or user security level information may in turn be appropriately secured and validated, e.g., by electronic signatures or other cryptographic methods. Likewise, it is conceivable that only user ID information or user type information is provided when accessing the ancillary information, while the relevant user security level is determined from the user ID information or the user type information, in particular before provisioning the relevant information.

According to a further embodiment of the present disclosure, the tracking information may comprise at least one information out of the group consisting of the asset ID information, the user information, the user type information, the user security level information, the asset location information, the user location information, time information, communication information, network transport information and network routing information.

By providing a plurality of correlated or interdependent information, the reliability of the individual information and thus generally of the reliability of the tracking information may be determined. E.g., in case an asset comprises specific ID information, the user scanning the asset is expected to receive the asset at the scanning location in an expected time period and also the network transport information and routing information transporting the information between the user and the computing back-end correlate, the asset location may be determined with a high level of confidence. Alternatively, in case the specific asset ID information is scanned by a user not expected to scan the ID information but providing apparently correct location information while the network routing information does not match the routing information expected for said particular location, the asset location may be determined only with a low level of confidence. In case the level of confidence is below a certain threshold, a tampering with the tracking may be assumed.

According to a further embodiment of the present disclosure, the database may store/may be adapted to store the ancillary information associated with the asset.

In other words, the database may store in addition to the tracking information, which may possibly comprise ID information, user information and or location information also the ancillary information associated with a particular asset. Providing a database storing all relevant information associated with a particular asset, may allow the easy provisioning of a centralised database. In addition to the received tracking relevant information and the ancillary information, the database may also store which information of the ancillary information has been provided to a particular user and may log said provisioning. The database may be in the form of a blockchain thereby allowing the secure storing of the information in a reliable and in particular untamperable manner that can easily be audited and verified.

According to a further embodiment of the present disclosure, the assets may comprise a localised ID information element attached to the asset and the localised ID information element may be adapted so to be rendered inoperable or to be destroyed in case of a removal from the asset.

The localised ID information element may be arranged so to essentially be destroyed or rendered inactive when being removed from the asset, at least in an unauthorised manner. E.g., in case the localised ID information element is an electronic element that is removed from the asset, by removing the element from the asset an electronic circuit may be destroyed and thereby rendered inoperable. Alternatively, in case of the localised ID information element being a barcode element or the like, i.e., an optical element, the removal of the element may render the visually depicted ID information and readable or incomprehensible. Thereby the removal of the localised ID information element from an asset and reattachment to a different asset is prevented. This avoids e.g., that the localised ID information element of a genuine asset is removed from the asset and attached to a counterfeit asset.

### BRIEF DESCRIPTION OF THE DRAWINGS

The present invention will now be described with reference to the accompanying drawings, in which:

FIG. 1 shows an exemplary embodiment of an asset tracking scenario according to the present disclosure.

FIG. 2 shows an exemplary embodiment of a system for asset tracking according to the present disclosure.

FIG. 3 shows an exemplary embodiment of a method for asset tracking according to the present disclosure.

FIG. 4 shows an exemplary embodiment of a method for asset tracking and information provisioning according to the present disclosure.

FIG. 5 shows an exemplary system overview of asset tracking and information provisioning according to the present disclosure.

### DETAILED DESCRIPTION

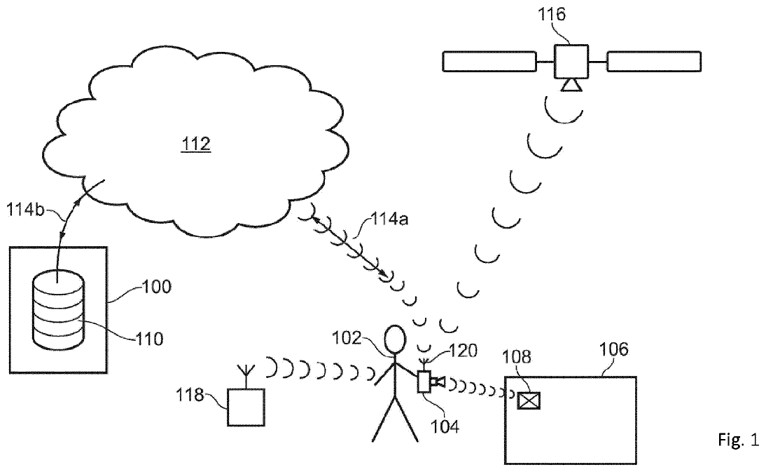

Now referring to FIG. 1, an exemplary embodiment of an asset tracking scenario according to the present disclosure is shown.

FIG. 1 shows a scenario for tracking of an asset according to the present disclosure. In this exemplary scenario, a user 102 is in progress of scanning an asset 106. In order to scan the asset, the user 102 is using a tracking device 104. The tracking device 104 is arranged for acquisition of an ID information 108 of the asset 106. ID information 108 may essentially correspond to a localised ID information element 108, which is attached to the asset 106. The localised ID information element 108 may in particular be attached to the asset 106 so that it is destroyed or otherwise rendered inoperable in case it is removed from asset 106. Destroying or otherwise rendering inoperable of the localised ID information element may essentially be understood that the tracking device 104 not being able any more to acquire the localised ID information element 108 and thus the associated ID information 108.

In case of an optical localised ID information element 108, e.g., a barcode like a QR code, the removal may essentially destroy the appearance of the localised ID information element 108 so that the barcode or at least the information conveyed within the barcode is not readable anymore by the tracking device 104. In case of an electronic localised ID information element 108, like an RFID tag or an electronic element comprising near field communication capability like e.g., Bluetooth, the removal of the localised ID information element 108 may render inoperable the electronic device e.g., by breaking the electronic circuit.

The user 102 is thus acquiring the ID information 108 from the localised ID information element 108 using tracking device 104. The tracking device 104 is further arranged to acquire a location, in particular a global location providing a unique reference to the position where the acquisition of the ID information was conducted. Exemplarily, the tracking device 104 may receive position information from a global positioning system like Galileo, GPS or GLONASS. The provision of the global position via a location provisioning system 116 is exemplified by a satellite 116. The satellite 116 may provide signals that allow the determination, possibly together with a plurality of further satellites, of a precise and unique global location by the tracking device 104.

Further methods of position determining are conceivable, e.g., by using a closed-circuit position determining system 118, e.g., a transponder 118, which in turn may provide a localised, near field signal to a tracking device 104. E.g., transponder 118 may provide a secure and unique ID signal to the tracking device 104 so that the tracking device 104 may determine to be in the vicinity of transponder 118. When the tracking device 104 thus acquires the ID information 108 and the transponder signal in close temporal relationship, it can be assured that the acquisition of the ID information 108 of the asset 106 has been performed in the vicinity of the transponder 118. Thus, it is possible to determine a relative location of the acquisition position with regard to the transponder 118. In case the location of the transponder 118 is reliably known, receiving the transponder signal may provide a reliable verification of the position of the acquisition of the ID information 108 of the asset 106 and thus of the location of the asset 106.

Tracking device 104 may be associated with a particular user 102, e.g., by requiring the user to log on to the tracking device 104 with their unique credentials, or the tracking device 100 for itself may exhibit a particular identification or user ID.

In the described scenario, the user 102/the tracking device 104 was thus able to ascertain the ID information 108 of the asset 106 at a defined location in conjunction with a particular user ID or user type associated with the user 102/the tracking device 104. At least part of this information eight sets, preferably the dataset comprising ID information 108, location information and user ID information/user type information, is transmitted to a system 100 for tracking of an asset. The system 100 may be located remotely from the location of the ID information acquisition of the asset 106, exemplified by a communication connection between the tracking device 104 and the system 100 connecting through the cloud 112, e.g., the Internet or a further appropriate communication network.

In order to communicate with the system 100, the tracking device 104 comprises a communication element 120. The tracking device 104 is establishing a communication connection 114a to the cloud 112 while the system 100 in turn establishes itself a communication connection 114b with the cloud 112. It follows that the tracking device 104 and the system 100 are in communicative connection via the cloud 112, e.g., the Internet or a further appropriate communication network.

System 100 comprises, inter alia, a database 110 for storing information relevant to the tracking of the asset. The information may be historical tracking information, location information, asset ID information, user ID information, user type information, user security level information, ID information on the closed-circuit position determining system/transponder and generally ancillary information on a particular asset 106.

When the user 102 provides the tracking information on the asset 106, like asset position, user position, user ID etc., the system 100 may store a subset or all of the received information in its database 110. The database may in particular be a blockchain type database that prohibits once written information from being altered subsequently, thereby establishing a reliable ledger of transactions, where the transactions correspond to particular tracking events of an asset. Thereby, an unalterable history of location trackings of assets can be established easily and reliably and in particular audit proof.

After providing the tracking information to the system 100, the user may preferably receive ancillary information associated with the asset 106 and/or the location of the asset 106. E.g., handling information, authenticity information, expiry information or information regarding the future of the asset may be provided to the user 102. E.g., by tracking the asset at a particular location, the system 100 may in turn provide instructions to the user what to do next with the asset 106. Thereby, a route of travel of the asset 106 may be dynamically adapted while the asset is in transit. Such a dynamic rerouting of the asset may further enhance the reliability of the transportation is only the current user has knowledge about the next/future destination of the asset 106. This results in a reduced sphere of knowledge about the travel path of the asset 106, possibly increasing reliability of transport. It is further conceivable that information required for the actual use of the asset is provided by the system 100 to the user 100 to only after establishing a location of the asset 106 and whether said location is valid, reliable and corresponds to the intended location of the asset 106 at a particular point in time. E.g., a code may be transmitted to the user 102 which is required to access the asset 106, or a container where the asset 106 is stored in.

By providing the ancillary information in response to a tracking of the asset 106 and in particular after verification by the system 100 of the correctness of the information from the user 102, the user 102 is incentivised to actually track the asset 106, e.g., by using tracking device 104, and communicating the tracking information to the system 100.

The tracking device 104 may be a dedicated tracking device or alternatively may e.g., be a portable computing device, like a smart phone, which may run a dedicated tracking application.

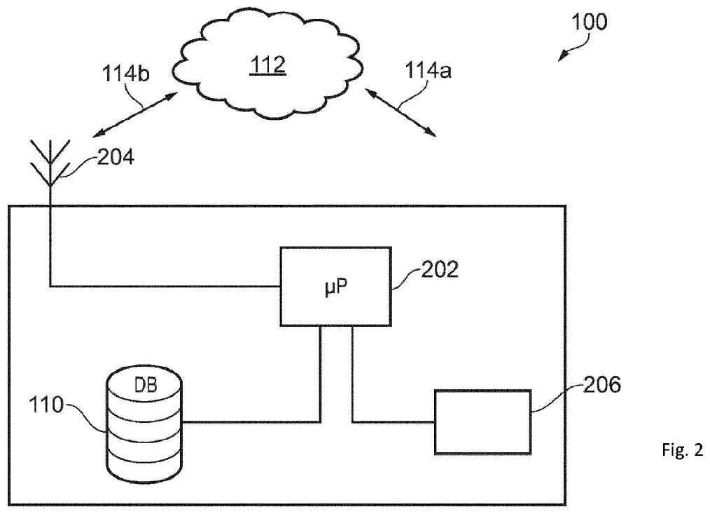

Now referring to FIG. 2, an exemplary embodiment of a system for asset tracking according to the present disclosure is shown.

In FIG. 2, the system 100 is shown in further detail. The system 100 comprises a processing element 202 microprocessor which is connected to a communication element 204. The communication element 204 is exemplarily depicted as an antenna. Further elements potentially required to operate the antenna 204 like power circuitry or encoding/decoding circuitry for wireless transmission are not specifically depicted in FIG. 2. Communication element 204 exemplarily is connected to processing element 202 internally of system 100 and operates a communication connection 114b externally of system 100. Communication connection 114b allows the communication of the system 100, in particular of the processing element 202, with remote devices through communication connection 114b.

In FIG. 2, communication connection 114b is shown as collecting to cloud 112, e.g., the Internet or a further suitable communication network. A further communication connection 114a, e.g., to a tracking device 104 like was depicted in FIG. 1 is indicated in FIG. 2. System 100/processing element 200 to adapted to communicate with remote devices wirelessly. Further attached to processing element 200 to a database 110, possibly stored on an appropriate storage medium like a memory module, and HDD were STD or the like. Further, a dedicated memory element 206 is exemplarily connected to processing element 202. Memory element 206 may comprise instructions, i.e., a program, for operating the system 100. In other words, memory element 206 may comprise instructions which, when executed by processing element 202 cause the processing element 202 to carry out the steps of a method 300 for tracking of an asset.

System 100 may thus receive information from a remote device like tracking device 104 of FIG. 1. The received information may comprise, inter alia, at least one information of a location of an asset and/or a user, ID information of a particular asset and information on the user. User information may be at least one of a user ID, a user type and a user security level. Upon receiving information, the system may access database 110 for verification of the information. E.g., the validity of a particular asset ID information may be verified by accessing database 110. Upon verification of the asset ID information, the system may retrieve ancillary information from the database 110, in particular ancillary information associated with a user ID/user type/user security level and provide said information to the user via communication connection 114b and 114a. Additionally or alternatively, system 100 may verify further received information before sending the ancillary information to the user. E.g., the system 100 may perform a plausibility verification of a provided asset location, thereby determining whether the asset 106 is still on its correct path of travel on the retail channel. Still further additionally or alternatively, the system may store at least a part of the received information in database 110, thereby creating a history of asset trackings of a particular asset. To reliably store the tracking information, the database 110 may in particular be embodied using blockchain technology.

Dependent on a specific tracking event, the system 100 may feed back information to the user 102 word to further relevant stakeholders of the transport channel. E.g., the OEM or additional distribution entities may be informed of a particular tracking event, either as a matter of course or because an abnormal tracking event is detected. E.g., in case a particular asset 106 is determined to be at a location which is irregular, a local distributor may be informed about that tracking event. In the case of grey market products, it is conceivable that once an asset is determined to be at a location not corresponding to the intended retail channel, both the original distributor as well as the local distributor are informed so to enable appropriate counteraction, e.g., alerting the relevant authorities, or at least documenting said tracking incident.

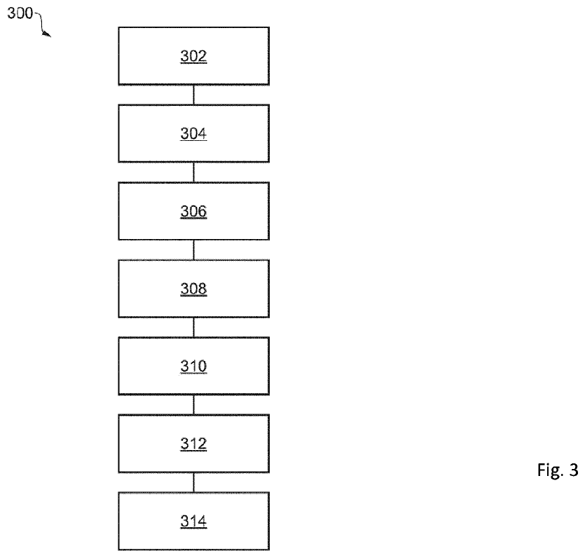

Now referring to FIG. 3, an exemplary embodiment of a method for asset tracking according to the present disclosure is shown.

The method 300 for tracking of at least one asset, comprises the steps of receiving 302 ID information of a particular asset, receiving 304 user information of a particular user, receiving 306 location information, wherein the location information is location information of the asset and/or the user, storing 308, in a database, tracking information based on at least one of the received information, associated with the asset, determining 310, based on at least one of the received information, whether to provide ancillary information associated with the asset to the user, determining 312, based on the user information, information to be transmitted to the user, wherein the information to be transmitted is at least a subset of the ancillary information associated with the asset, and providing 314 said information to be transmitted to the user.

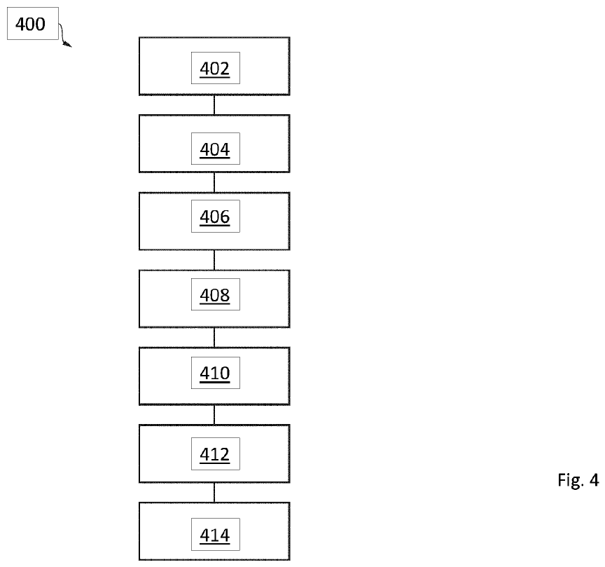

FIG. 4 shows an exemplary embodiment of a method for asset tracking and information provisioning according to the present disclosure.

The method 400 for asset tracking and information provisioning, comprises the steps providing 402 a physical asset 106 comprising ID information 108, providing 404 a virtual NFT asset 500 comprising NFT-ID information, wherein the ID information of the physical asset 106 and the NFT-ID information of the virtual asset 500 are linked, providing 406 user information of a user linked to the physical asset 106 and/or the virtual NFT asset, storing 408, in a blockchain, tracking information associated with the physical asset and the NFT asset and based on at least one of the provided information, determining 410, based on at least one of the physical asset ID information, the virtual NFT asset NFT-ID information and the user information, information available to and/or to be transmitted to the user, wherein the determining information comprises determining the information as a subset of ancillary information associated with the physical asset based on at least one of the ID information, the NFT-ID information, the user information, user ID information, the validity of the ID information, the validity of the NFT-ID information, the validity of the user information, the validity of the user ID information, user type information, user security level information, and providing 412 said subset of ancillary information to the user upon request.

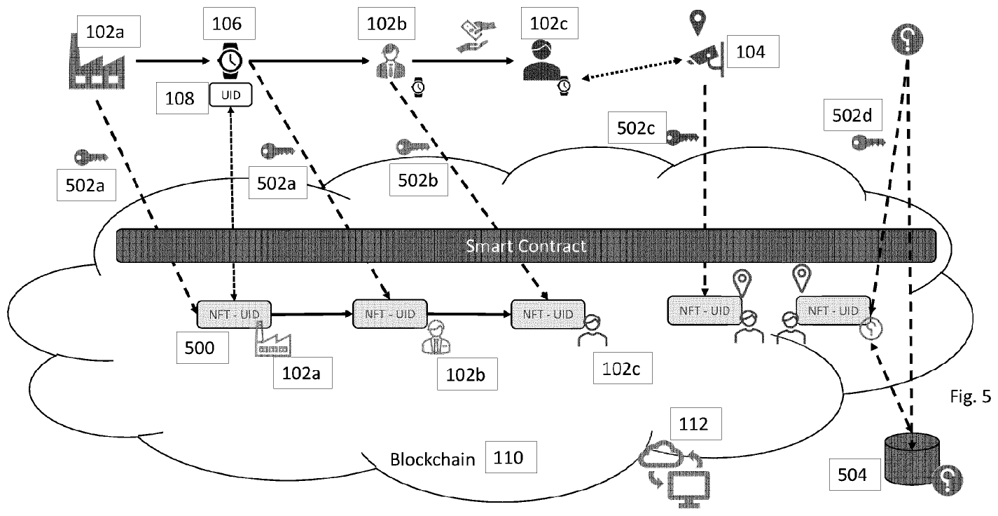

FIG. 5 shows an exemplary system overview of asset tracking and information provisioning according to the present disclosure.

In FIG. 5, a user 102a, exemplarily the manufacturer of a physical asset 106, has manufactured a watch for distribution. The physical asset 106 comprises ID information 108, exemplarily a unique ID UID associated with the physical asset 106. The unique ID is securely linked to the physical asset 106. E.g., the UID may be engraved on a part of the physical asset 106 and may thus not be copyable. Additionally, or alternatively, the UID may be stored in a secure element as part of the physical asset 106.

Parallel to manufacturing the physical asset 106, user 102a has generated a virtual NFT asset 500 depicted by unique NFT ID, NFT-UID. The UID of the physical asset 106 and the NFT-UID of the virtual NFT asset 500 are linked as depicted by the dashed vertical arrow in FIG. 5. The virtual NFT asset 500 is stored as part of a blockchain 110 in a networking computing environment/cloud 112. To generate the virtual NFT asset, user 102a uses key 502a, e.g., a public-private key pair allowing to verify ownership of the virtual NFT asset 500.

From user 102a, the physical asset 106 is transferred to a further user 102b, e.g., a distributor for the physical asset 106. Parallel to the physical/real world forwarding of the physical asset 106 from user 102a to user 102b, the virtual NFT asset 500 may be transferred in parallel to user 102b. Said transfer may be performed on the blockchain 110 by transferring the virtual NFT asset 500 from the wallet of user 102a to the wallet of user 102b using the private key of key 502a. Once the virtual NFT asset 500 has been transferred from user 102a to user 102b, ownership of the virtual NFT asset 500 by user 102b is publicly verifiable.

User 102b may subsequently sell the watch/physical asset 106 to an end user 102c. in order to record the transfer on the blockchain, user 102b uses their key 502b so that the virtual NFT asset 500 is associated with the wallet of the user 102c. Alternatively, an automatic transfer of ownership may be performed. Tracking device 104, exemplarily embodied as a camera which may be located at the retail premises of user 102b may record the transfer and may in turn use a key 502c to transfer the virtual NFT asset 500 from the wallet of user 102b to the wallet of user 102c. this transfer may include location data, e.g., GPS data of the location of the transfer. By including the transfer location, and virtual asset transfer may be stored with increased reliability, in particular if subsequently verified by a further user on the value chain.

At every step of the value chain, i.e., at each instance where the virtual NFT asset belongs to a particular user 102a,b,c, ancillary information may be requested associated with the virtual NFT asset 500 and thus with the physical asset 106. The ancillary information retrievable, i.e., accessible by a particular user, may depend on the position, role, ID etc. of a user of the value chain. E.g., user 102a may retrieve different information from the blockchain in relation to the value chain than user 102b or user 102c. A smart contract in the blockchain may manage the rules associated to the NFT, e.g., which user may access and/or write which data to the blockchain. The respective rights, managed by the smart contract, may depend on at least any one of physical asset ID information, virtual NFT asset NFT-ID information, user information, user ID information, validity of the ID information, validity of the NFT-ID information, validity of the user information, validity of the user ID information, user type information, user security level information and location information of the physical asset and/or the user. Also in this regard, tracking device 104 may e.g., determine at least one of the identity of the user, the physical asset and the location and information dependent on at least some of these parameters may be presented to a particular user. A smart contract may also determine which users may modify a property or information associated with a particular virtual NFT asset. Most fundamentally, the smart contract may determine if a user has the right to own or transfer ownership of a particular virtual NFT asset. The smart contract may define rules for changing asset properties or user categories for information distribution or retrieval. E.g., a particular physical asset may be sold only in a specific geographic area, e.g., the country of a particular distributor that is currently registered as the owner of the virtual NFT asset. In case the sale is attempted outside of the geographic area, e.g., tracking device 104 registers the transfer not taking place within the specific geographic area, the transfer of the virtual NFT asset from the current owner to the new owner may be prohibited. In order to control access to the ancillary data and to provide a subset of the ancillary data to a user in accordance with their authorization order to allow modification of the data, a further private server 504, associated to a so-called oracle may be employed. In a blockchain environment, an oracle may be an entity providing information from the real world to the blockchain. Here, the private server 504 may be used to store confidential information that may not be divulgated to any users.

The oracle may receive the request for ancillary data, e.g. a particular subset of ancillary data, and may determine based on at least any one of physical asset ID information, virtual NFT asset NFT-ID information, user information, user ID information, validity of the ID information, validity of the NFT-ID information, validity of the user information, validity of the user ID information, user type information, user security level information and location information of the physical asset and/or the user whether to provide data and/or to determine which data to provide to a user requesting the data.

The scanning asset can take the ID of the asset, signed the information to the blockchain as a positioning “oracle”. The positioning oracle device should include a secure element to store the oracle private key and sign the “Id Position Date” data to send to the blockchain. In the blockchain a smart contract will be able check that the oracle signature is conform, associate the asset ID to an NFT and add the positioning-date in the properties of the NFT. In a blockchain environment, an oracle is an entity providing information from the real world to the blockchain. It is beneficial to ensure that those information have not been corrupted in any way. A challenge here is on how the information has been collected and if they are effectively authentic. In this embodiment, the tracking device 104 providing the location of the asset 106 (e.g., the watch) may be seen as an oracle. To be trusted for instance, the camera may be installed by a trusted company and include a secure element including a key pair. An Oracle ID (e.g., the public key of the oracle/tracking device 104) may be required to be enrolled in the smart contact as an oracle entity. The location information associated to the asset 106 may be signed by the secure element embedded in the tracking device 104 with the private key of the tracking device 104.

Briefly summarizing and using different terminology, the present disclosure provides a technical solution to use a dedicated platform as an asset tracking engine and for collecting the location of the assets/transported goods. Each stakeholder/user having the goods at some stage will connect to the platform/system for transmitting the location of the goods. In return the system may provide information about the goods depending on the type of the stakeholder. The object to be tracked is identified by an ID solution, e.g., ID information, such as a QR code, Cryptoglyph or RFID. Alternatively, an electronic solution may be employed, for example a secure element, affixed to or incorporated into the physical asset. Such a secure element may be e.g., a processor or memory chip which can store information in an unalterable and secure, e.g., cryptographically secure manner, and which information is secured against copying, or where a copying of the information can be detected. For example, in case the secure element is part of an electronic circuit of the physical asset, a removal for reattaching of the secure element to a different physical asset may be technically impossible, e.g., may result in the destruction of the secure element altogether.

Aging, if a secure element is associated with the asset 106, the secure element may contain a key pair. The private key may be kept in the secure element and will be used to identify the secure element/the asset 106, and the public key will be associated to the ID of asset stored in the NFT. For instance, the asset NFT ID may be the hash of the public key stored in the secure element associated to with the asset.

The ID is inserted at the manufacturing step, associated with the goods and loaded into the platform database. The object usually travels from the manufacturer to various distributors before arriving at the final client. At each station during the route, the holder of the object is able to read the ID and connect with the platform to upload the position of the object. In return the platform can download additional information about the object such as the conservation requirements, the expiration date of the object, composition of the object, etc.

The need for additional information is not the same for a distributor than for a client. The distributor is e.g., interested in the storage requirements, the expiration date and potential risk associated with the product. The final client is interested in the user manual, the limitation or combination to be avoid (e.g., for pharmaceuticals).

The platform may thus provide to each stakeholder the type of information needed in return to the location of the object. The platform can also generate a report showing the route of an object and detect abnormal situations, e.g., by using artificial intelligence or applying a machine learning algorithm.

A tracking platform for tracking objects, said object carrying an identification number having a signature, said platform being connected with a database comprising for each identification number, at least two set of data, each set of data being associated with a security level, said platform being configured to receive from a user a request comprising an identification number of an object, a user security level, a location of said user, verify the signature of the first identification number and in case the signature is not correct, send a notification to the first user. In case the signature is correct, verify the security level of the user and select the set of data associated with said security level, send all or part of the set of data to the user, and record the location of the user in association with the identification number.

It is to be understood that the invention is not limited to the embodiments described above, and various modifications and improvements may be made without deviating from the concepts described here. Any of the features described above and below may be used separately or in combination with any other features described herein, provided they are not mutually exclusive, and the disclosure extends to and includes all combinations and sub-combinations of one or more features described herein.

Finally, it should be noted that the term “comprising” not exclude other elements or steps, and that “a” or “one” does not exclude the plural. Elements that are described in relation to different types of embodiments can be combined. Reference signs in the claims shall not be construed as limiting the scope of a claim.

### LIST OF REFERENCE NUMERALS

100 system for tracking of an asset
102 user
104 tracking device
106 physical asset
108 ID information/localized ID information element
110 database/blockchain
112 networking computing environment/cloud
114,a,b communication connection
116 location provisioning system/satellite
118 closed circuit position determining system/transponder
120 communication element
202 processing element/μP
204 communication element/antenna
206 memory element
300 method for tracking of an asset
302 receiving ID information
304 receiving user information
306 receiving location information
308 storing tracking information
310 determining to provide ancillary information
312 determining information to the user
314 providing information to the user
400 method for tracking of an asset
402 providing a physical asset
404 providing a virtual NFT asset
406 providing user information
408 storing tracking information
410 determining information available to and/or to be transmitted to the user
412 providing said subset of ancillary information
414 providing location information
500 virtual NFT asset
502 key
504 oracle

1. A method for tracking of at least one asset, comprising:
receiving ID information of an asset;
receiving user information of a user;
receiving location information, wherein the location information is location information of at least one of the asset or the user;
storing, in a database, tracking information based on at least one of the received information associated with the asset;
determining, based on at least one of the received information, whether to provide ancillary information associated with the asset to the user;
determining, based on the user information, information to be transmitted to the user, wherein the information to be transmitted is at least a subset of the ancillary information associated with the asset; and
providing the determined information to be transmitted to the user.

2. The method of claim 1, wherein the ID information includes signature information and wherein the ID information is cryptographically secured ID information, the method further comprising verifying at least one of a signature of the ID information or the cryptographically secured ID information for determining a validity of the ID information.

3. A system for tracking of at least one asset, the system comprising:
a communication element adapted for communication with at least one user of the system;
a database (110) for storing information about at least one of an asset or a user; and
a processing element, adapted to:
receive ID information of an asset;
receive user information of a user;
receive location information, wherein the location information is location information of at least one of the asset and/or the user;
store, in the database, tracking information based on at least one of the received information, associated with the asset;
determine, based on at least one of the received information, whether to provide ancillary information associated with the asset to the user;
determine, based on the user information, information to be transmitted to the user, wherein the information to be transmitted is at least a subset of the ancillary information associated with the asset; and
provide the determined information to be transmitted to the user.

4. The system of claim 3, wherein the ID information includes signature information, wherein the ID information is cryptographically secured ID information, and wherein the processing element is adapted to verify a signature of the ID information for determining a validity of the ID information.

5. The method of claim 1, wherein the ID information of the asset is acquired by the user from the asset in a near field at a location of the asset indicated by the location information.

6. The method of claim 1, wherein the asset comprises a localized ID information element (108), and wherein the localized ID information element is associated with the ID information so that the user can acquire the ID information in a near field at a location of the asset indicated by the location information.

7. The method of claim 1, further comprising storing the ancillary information associated with the asset in the database.

8. A method for asset tracking and information provisioning, comprising:
providing a physical asset comprising ID information;
providing a virtual non-fungible token (NFT) asset comprising NFT-ID information, wherein the ID information of the physical asset and the NFT-ID information of the virtual NFT asset are linked;
providing user information of a user linked to at least one of the physical asset and/or the virtual NFT asset;
storing, in a blockchain, tracking information associated with the physical asset and the virtual NFT asset and based on at least one of the provided information;
determining, based on at least one of the ID information of the physical asset, the NFT-ID information of the virtual NFT asset, or the user information, information at least one of available to and/or to be transmitted to the user, wherein determining the information comprises determining the information as a subset of ancillary information associated with the physical asset based on at least one of the ID information, the NFT-ID information, the user information, user ID information, a validity of the ID information, a validity of the NFT-ID information, a validity of the user information, a validity of the user ID information, user type information, or user security level information; and
providing the subset of ancillary information to the user upon request.

9. (canceled)

10. The method of claim 8, further comprising:
storing information on the virtual NFT asset in a blockchain, wherein the virtual NFT asset is an NFT.

11. The method of claim 8, wherein linking the ID information of the physical asset and the NFT-ID information of the virtual NFT asset comprises at least one of a secured link, a cryptographically secured link, a signed link, or an unalterable link.

12. The method of claim 8, wherein linking of the user to the virtual NFT asset comprises linking at least one of ownership or proprietorship of the physical asset to the said user.

13. The method of claim 8, further comprising:
transferring the virtual NFT asset from the user to a second user when at least one of ownership or proprietorship of the physical asset is transferred from the user to the second user.

14. The method of claim 8, further comprising:
providing location information, wherein the location information is location information of at least one of the asset or the user; and
determining the information as a subset of ancillary information associated with the physical asset based on at least one of the ID information, the NFT-ID information, the user information, user ID information, a validity of the ID information, a validity of the NFT-ID information, a validity of the user information, a validity of the user ID information, user type information, user security level information, or location information of at least one of the physical asset or the user.

15. (canceled)

16. The method of claim 1, wherein user information comprises at least one of user ID information, user type information, or user security level information, and wherein determining whether to provide ancillary information comprises determining at least one of a validity of the ID information, a validity of the user information, the user ID information, the user type information, the user security level information, or the location information.

17. The method of claim 16, wherein the tracking information comprises at least one of the asset ID information, the user information, the user type information, the user security level information, the asset location information, the user location information, time information, communication information, network transport information, or network routing information.

18. The system of claim 3, wherein user information comprises at least one of user ID information, user type information, or user security level information, and wherein the processing element, for determining whether to provide ancillary information, is adapted to determine at least one of a validity of the ID information, a validity of the user information, the user ID information, the user type information, the user security level information, or the location information.

19. The system of claim 18, wherein the tracking information comprises at least one of the asset ID information, the user information, the user type information, the user security level information, the asset location information, the user location information, time information, communication information, network transport information, or network routing information.

20. The method of claim 6, wherein the asset comprises a localized ID information element attached to the asset.

21. The method of claim 6, wherein the localized ID information element is adapted to be rendered inoperable or to be destroyed in case of a removal from the asset.
